(19) United States
(12) Patent Application Publication
(10) Pub. No.: US 2007/0130121 A1
(43) Pub. Date: Jun. 7, 2007

(54) System and method of displaying a document including an embedded link

(76) Inventor: Blaine H. Dolph, Western Springs, IL (US)

Correspondence Address: IBM CORP. (CLG);c/o CARDINAL LAW GROUP, 1603 ORRINGTON AVENUE, SUITE 2000, EVANSTON, IL, 60201, US

(21) Appl. No.: 11/291,544

(22) Filed: Dec. 1, 2005

(51) Int. Cl. G06F 17/30

(52) U.S. Cl. 707/3

(57) ABSTRACT

A method and system of displaying a document including an embedded link within text of the document. The method includes receiving an open document command. It is determined whether at least one link is embedded in the text of at least a portion of the document, responsive to the open document command. Content associated with the embedded link is retrieved based on the determination. The retrieved content and document are displayed simultaneously.

### TECHNICAL FIELD OF THE INVENTION

The present invention relates generally to computer systems and in particular to displaying a document including an embedded link.

### BACKGROUND OF THE INVENTION

In numerous computer document programs, such as Microsoft Word®, Microsoft Notepad®, Lotus Amipro®, Lotus Notes®, Yahoo Mail®, Corel Wordperfect®, or a Webpage, it is common practice to reference an external Webpage. To view the external Webpage, a user typically clicks on a link directing an additional program to open and display the contents of the Webpage. As two or more documents are open on one screen, it can be difficult to view the contents of the original and newly opened documents simultaneously.

Therefore, it would be desirable to provide a strategy for embedding Web site content into a document that would overcome the aforementioned and other disadvantages.

### SUMMARY OF THE INVENTION

One aspect of the present invention provides a method of displaying a document including an embedded link within text of the document. The method includes receiving an open document command. It is determined whether at least one link is imbedded in the text of at least a portion of the document, responsive to the open document command. Content associated with the embedded link is retrieved based on the determination. The retrieved content and document are displayed simultaneously.

Another aspect of the present invention provides computer usable medium including a program for displaying a document including an embedded link within text of the document. The medium includes computer readable program code for receiving an open document command and computer readable program code for determining whether at least one link is embedded in the text of at least a portion of the document, responsive to the open document command. The medium further includes computer readable program code for retrieving content associated with the embedded link based on the determination; and computer readable program code for simultaneously displaying the retrieved content and document.

Another aspect of the present invention provides a system for displaying a document including an embedded link within text of the document. The system includes means for receiving an open document command and means for determining whether at least one link is embedded in the text of at least a portion of the document, responsive to the open document command. The system further includes means for retrieving content associated with the embedded link based on the determination; and means for simultaneously displaying the retrieved content and document.

The foregoing and other features and advantages of the invention will become further apparent from the following detailed description of the presently preferred embodiments, read in conjunction with the accompanying drawings. The detailed description and drawings are merely illustrative of the invention, rather than of the invention being defined by the appended claims and equivalents thereof.

### BRIEF DESCRIPTION OF THE DRAWINGS

FIG. 1 illustrates a system of embedding Web site content into a document, in accordance with one embodiment of the present invention;

FIG. 2 illustrates a flow chart of a method of displaying a document including an embedded link within text of the document, in accordance with one embodiment of the present invention;

FIG. 3 illustrates a first Web browser, in accordance with one embodiment of the present invention;

FIG. 4 illustrates a second Web browser, in accordance with one embodiment of the present invention;

FIG. 5 illustrates the fist Web browser of FIG. 3 including the second Web browser of FIG. 4, in accordance with one embodiment of the present invention;

FIG. 6 illustrates the a portion of a document that is updated, in accordance with one embodiment of the present invention; and

FIG. 7 illustrates an updated and interactive Web browser, in accordance with one embodiment of the present invention.

### DETAILED DESCRIPTION OF THE PRESENTLY PREFERRED EMBODIMENTS

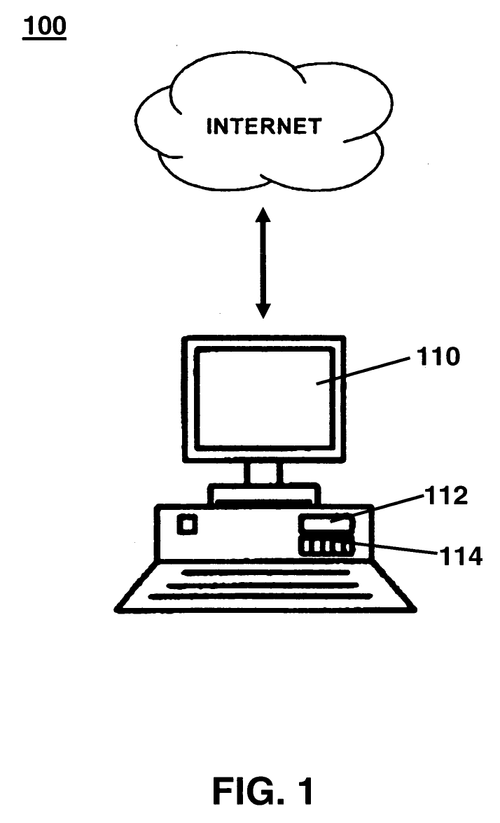

FIG. 1 illustrates a system of embedding Web site content into a document, in accordance with one embodiment of the present invention, and shown generally by numeral 100. System 100 includes a computer 110 electronically connected to the World-Wide-Web. Those skilled in the art will appreciate the there are a myriad of types of electronic devices and connections that can be adapted for use with the present invention.

In one embodiment, the computer 110 includes a microprocessor (CPU) that performs the functions of a general purpose processor. In one embodiment, processor is implemented as a microcontroller, controller, or host processor. In an example, processor is implemented as an application specific integrated circuit (ASIC). Computer 110 includes a hard drive 112 and memory 114 for storing Web page information and links, caches, programs, and the like.

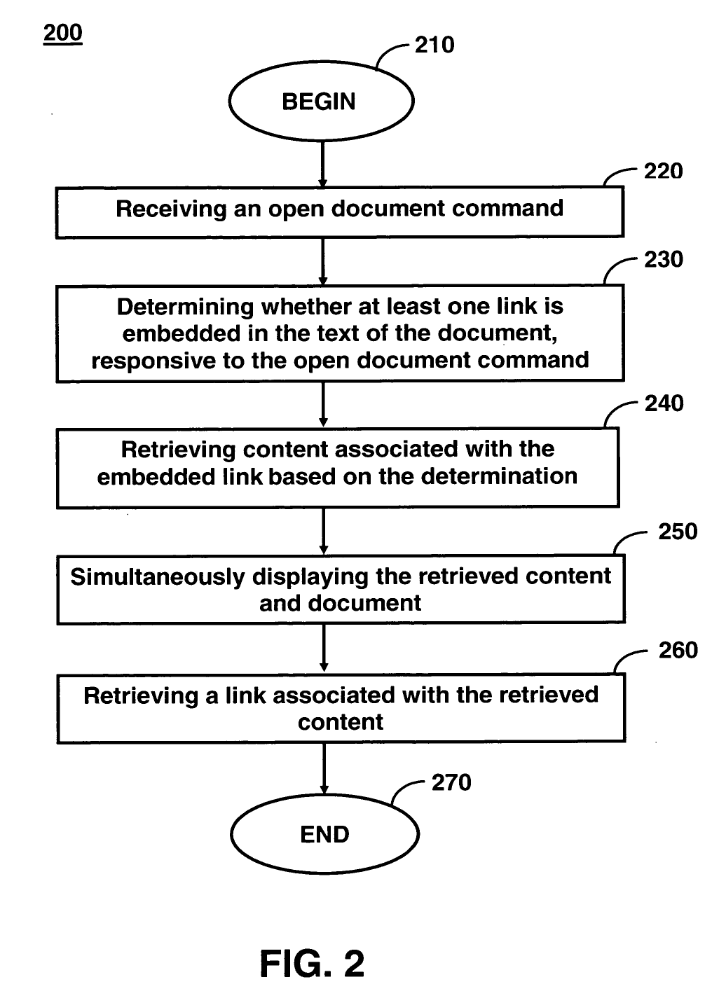

FIG. 2 illustrates a flowchart 200 representative of one embodiment of a method of displaying a document including an embedded link within text of the document. Method 200 begins at 210. The present invention can take the form of a computer usable medium including a program for capturing, processing, and manipulating a document in accordance with the present invention. The program, stored in the computer usable medium, includes computer program code for executing the method steps described and illustrated in FIG. 2.

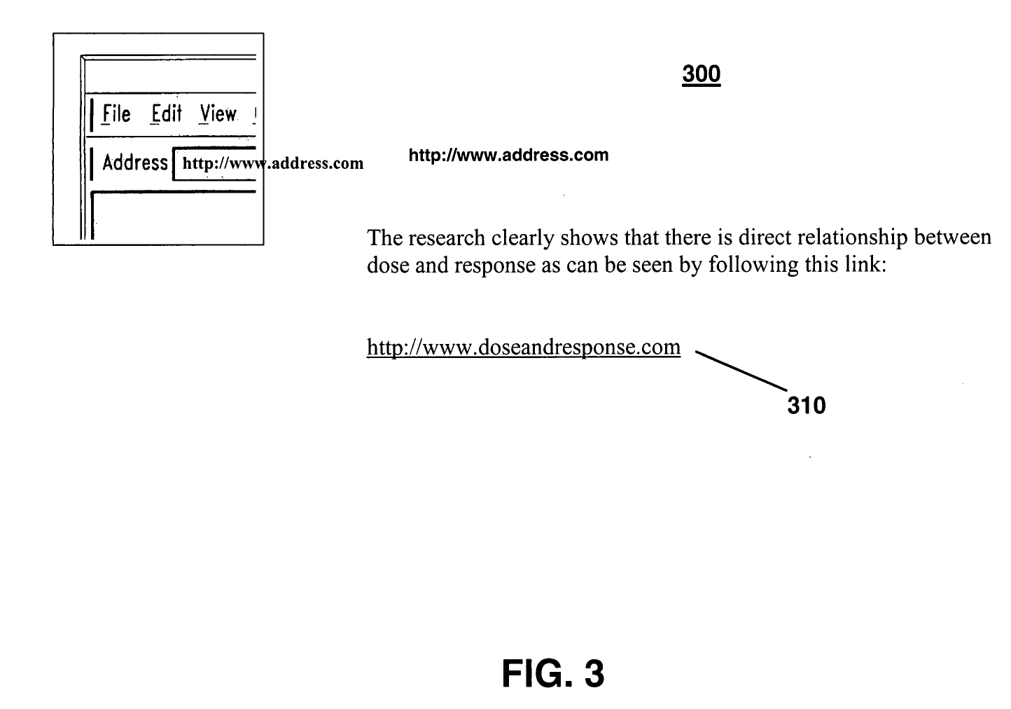

At step 220, an open document command is received by an application executing on, for example, computer 110. In one embodiment, the open document command can be received in response to a mouse point-and-click, a touch-screen press, a keypad selection, and the like. In one embodiment, the document 300 is a Web browser, which is shown in FIG. 3. In another embodiment, document can be a word processing program, a spreadsheet, and the like. The opening of documents is known in the art. The application can be any computer implemented instruction set that receives input and displays output on a display. For example, the application can be a word processing program, spreadsheet, web browser or similar such program.

At step 230, the application determines whether at least one link 310 is imbedded in the text of at least a portion of the document, responsive to the open document command. In one embodiment, the at least one link 310 is detected automatically. For example, the link 310 is a Uniform Resource Locator (URL) and can be searched for and detected in the document automatically. A variety of techniques may be employed to determine documents that include URLs and are linked to or referenced in another document. For example, a program may parse the document searching the source code for anchor tags, the hrefs of anchor tags, standard link prefaces such as “http”, and the like. Link 310 functions as an indicator of a Web page as understood in the art.

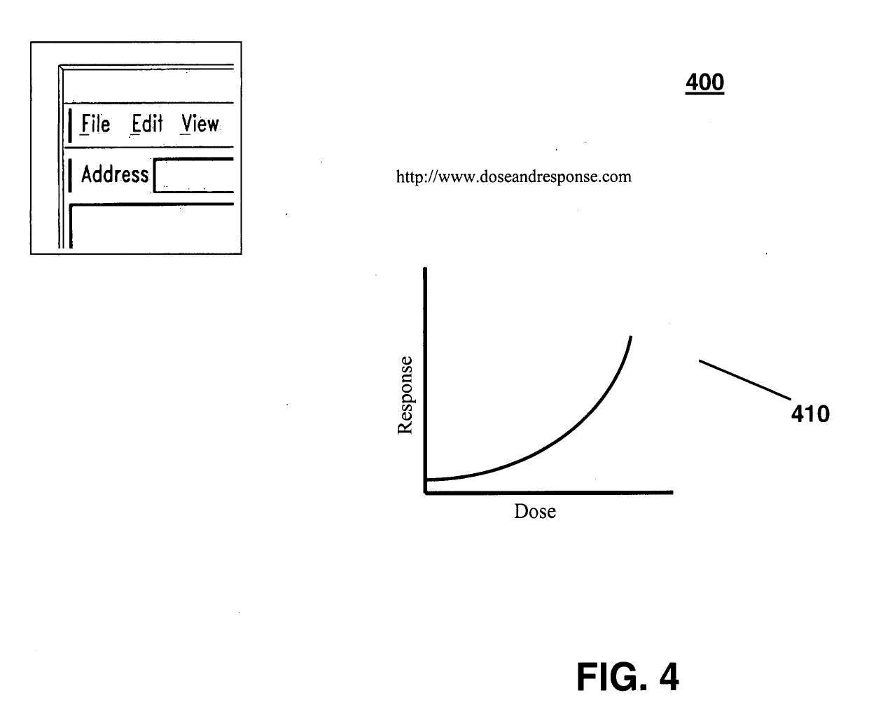

At step 240, content 410 associated with the embedded link, which is shown in FIG. 4, is retrieved by the application based on the determination. In one embodiment, Web site content is retrieved as a static image or “snapshot”. The snapshot can be in the form of numerous image formats known in the art including, but not limited to a .bmp image file, a .jpeg image file, a .gif image file, and the like. In another embodiment, the content 410 is retrieved repeatedly. As such, updated information can be provided. In another embodiment, the links are added to an image map of the static image.

In one embodiment, the Web site content is null; sometimes referred to as a “dead link”. In this case, the link 310 is simply displayed as shown in FIG. 3. This can occur if the network connection is inoperable or if the target Web page has expired.

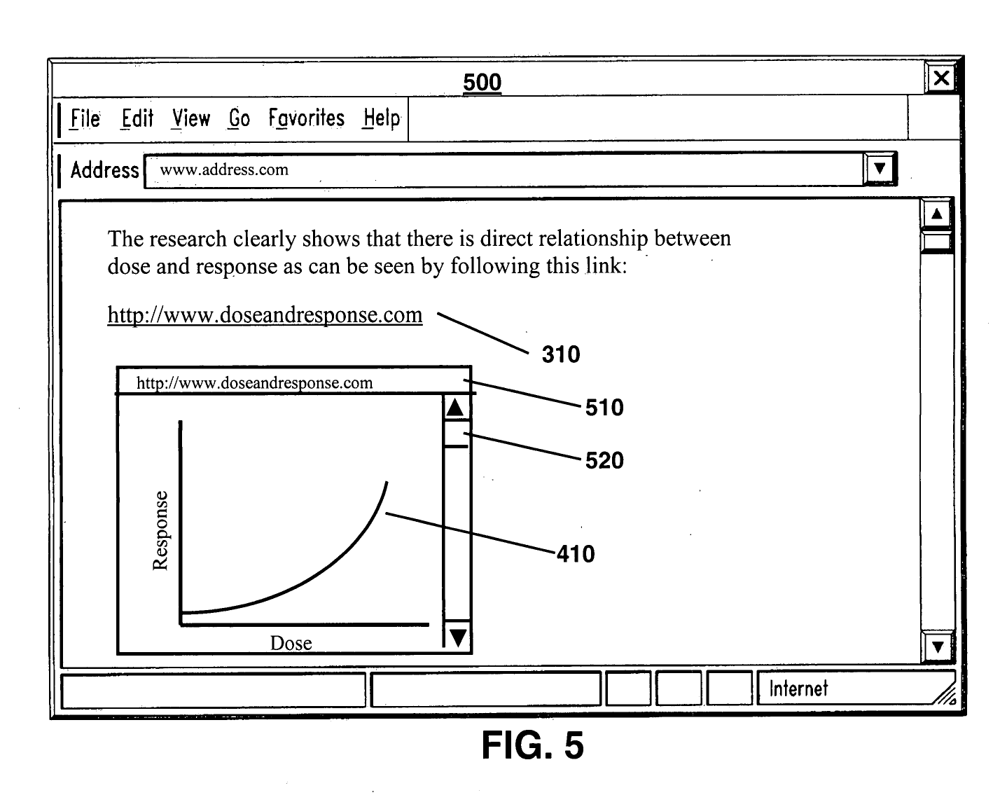

At step 250, document 500 and the retrieved content 410 are displayed simultaneously on a display by the application, which is shown in FIG. 5. As used herein, a “simultaneous” display includes a substantially simultaneous display. In one embodiment, the content 410 is retrieved within a document container 510. Document container 510 allows scrolling of the embedded information via a scrollbar 520. Content 410 is shown in a static manner within the document 500, as content 410 is derived from a .gif file in this embodiment. In one embodiment, retrieving content associated with the embedded link includes embedding dynamic programming language content associated with the link in the document 500. Examples of the dynamic programming languages include, but are not limited to, java server pages (jsp), active server pages (asp), cold fusion, and Perl.

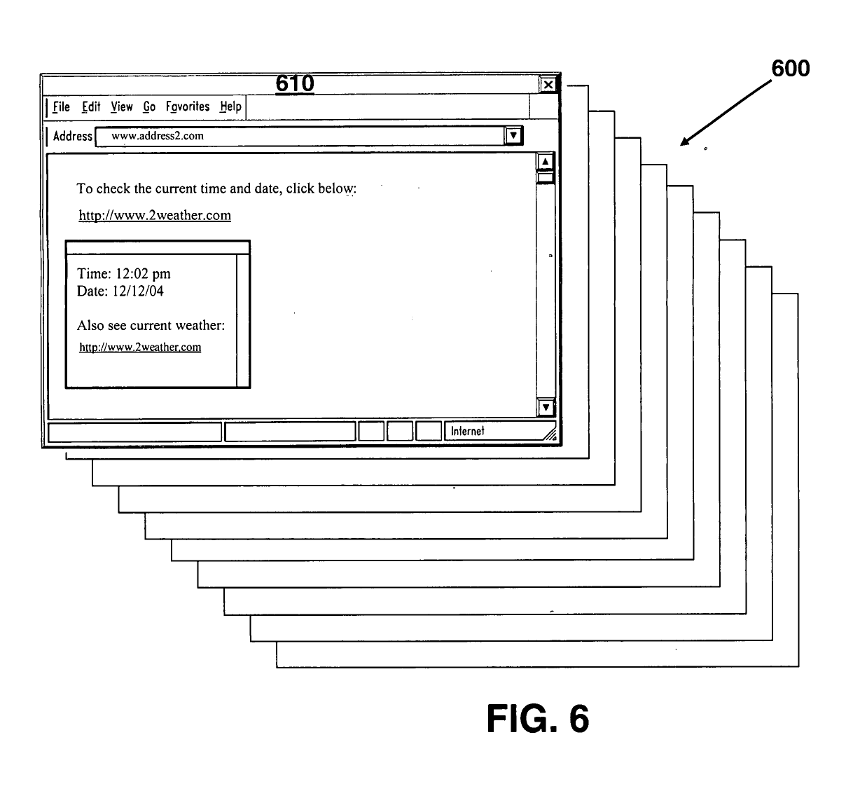

In one embodiment, a final document 600, which includes the simultaneously displayed retrieved content and document, is a large document (e.g., 10+ pages or a predetermined multiple of the content level than can be displayed on a display device), as shown in FIG. 6. As such, retrieving Web site link content for the entire document can require substantial time, bandwidth, disk space, memory, and the like. In one embodiment, the size of the displayed content associated with the embedded link is configured based on a predetermined size or user preferences. For example, based on receiving an open document command, the application determines that the content associated with the embedded link(s) is too large for display, based on either graphic size (i.e., the size of the image to be displayed) or file size (i.e., the physical size as measured in bytes of the content to be displayed). Based on this size determination, the application determines whether a predetermined portion (e.g., a page) of the document includes at least one embedded link, as well as the number of links and the size of the content associated with the at least one embedded link. Based on the size of the content, the application determines whether to display only a portion of the associated content within the document, or to adjust a magnification level to display more or less of the associated content within the document. In one embodiment, the application is configured to display only the content associated with the first three links, while in other embodiments, the application is configured to display only content sized to fit within a predetermined window physical size (e.g., 300 pixels by 300 pixels). Based on the display size and/or bandwidth available to the application, the document displays more or less of the content associated with at least one of the embedded links.

In another example, a document includes 10 pages, and includes one link per page. The application determines which, if any, links are displayed on a display associated with the document. Based on a link within a current display, the application retrieves the content associated with the displayed link, and displays that associated content. Based on a determination of a previously undisplayed link on the display, the application retrieves the content associated with the new link and displays that associated content.

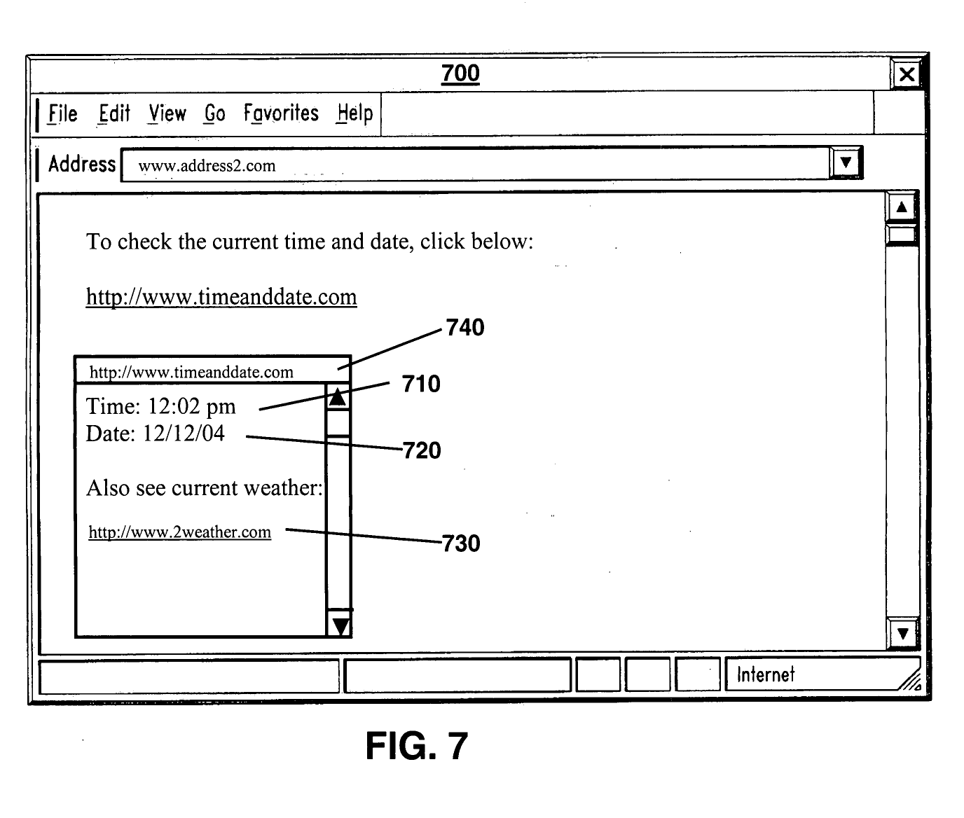

Referring to FIG. 7, in one embodiment, a final document 700 is an updated and interactive Web browser. In another embodiment, the final document is any variety of other documents including Web browser(s). Time 710 and date 720 information are repeatedly retrieved at predetermined intervals (e.g., every second or less) to show updated information, as understood in the art. In addition, an embedded link 730 is provided within the document container 740. The embedded link 730 can be selected thereby providing another document container to be opened within the final document 700, or within the document container 740. As such, a fully clickable Webpage is embedded within the final document 700. In another or the same embodiment, information such as statistics, video, and other information can be provided virtually in real time within the dynamic document container.

Method 200 terminates at step 270 and is repeated as appropriate.

It is important to note that the figures and description illustrate specific applications and embodiments of the present invention, and is not intended to limit the scope of the present disclosure or claims to that which is presented therein. While the figures and description present a program run on a master/client computer system, the present invention is not limited to that format, and is therefore applicable to other computer network formats. Upon reading the specification and reviewing the drawings hereof, it will become immediately obvious to those skilled in the art that embodiments of the present invention are possible, and that such embodiments are contemplated and fall within the scope of the presently claimed invention.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A method of displaying a document including an embedded link within text of the document, the method comprising:
receiving an open document command;
determining whether at least one link is embedded in the text of at least a portion of the document, responsive to the open document command;
retrieving content associated with the embedded link based on the determination; and
simultaneously displaying the retrieved content and document.

2. The method of claim 1 wherein determining whether at least one link is embedded in the text of at least a portion of the document comprises determining whether a predetermined portion of the document contains at least one link.

3. The method of claim 2 wherein the predetermined portion comprises a page of the document.

4. The method of claim 1 wherein the content comprises a static image.

5. The method of claim 1 wherein the content is retrieved repeatedly.

6. The method of claim 1 wherein retrieving content associated with the embedded link comprises embedding dynamic programming language content associated with the embedded link in the document.

7. The method of claim 1 wherein the content is retrieved into a document container.

8. The method of claim 1 further comprising retrieving an external link associated with the retrieved content.

9. A computer usable medium including a program for displaying a document including an embedded link within text of the document, the medium comprising:
computer readable program code for receiving an open document command;
computer readable program code for determining whether at least one link is embedded in the text of at least a portion of the document, responsive to the open document command;
computer readable program code for retrieving content associated with the embedded link based on the determination; and
computer readable program code for simultaneously displaying the retrieved content and document.

10. The computer usable medium of claim 9 wherein determining whether at least one link is embedded in the text of at least a portion of the document comprises determining whether a predetermined portion of the document contains at least one link.

11. The computer usable medium of claim 10 wherein predetermined portion comprises a page of the document.

12. The computer usable medium of claim 9 wherein the content comprises a static image.

13. The computer usable medium of claim 9 wherein the content is retrieved repeatedly.

14. The computer usable medium of claim 9 wherein retrieving content associated with the embedded link comprises embedding dynamic programming language content in the document.

15. The computer usable medium of claim 9 wherein the content is retrieved into a document container.

16. The computer usable medium of claim 9 further comprising computer readable program code for retrieving an external link associated with the retrieved content.

17. A system for displaying a document including an embedded link within text of the document, the system comprising:
means for receiving an open document command;
means for determining whether at least one link is embedded in the text of at least a portion of the document, responsive to the open document command;
means for retrieving content associated with the embedded link based on the determination; and
means for simultaneously displaying the retrieved content and document.
